(19) United States
(12) Patent Application Publication
(10) Pub. No.: US 2005/0100707 A1
(43) Pub. Date: May 12, 2005

(54) Folding and rotating toroidal structure

(76) Inventor: John Houston, New York, NY (US)

Correspondence Address: GOTTLIEB RACKMAN & REISMAN PC, 270 MADISON AVENUE, 8TH FLOOR, NEW YORK, NY, 100160601, US

(21) Appl. No.: 10/910,751

(22) Filed: Aug. 3, 2004

Related U.S. Application Data
(60) Provisional application No. 60/492,867, filed on Aug. 6, 2003.

(51) Int. Cl. B32B 5/00

(52) U.S. Cl. 428/98

(57) ABSTRACT

A distortionless foldable and rotatable image display structure is provided. The structure includes a pair of polygonal display units each defined by the same number image diamonds. Each image diamond of each display unit is rhombus-shaped. The image diamonds of either polygonal display unit together selectively define two different visual presentations with each visual presentation viewable depending upon the rotational position of the display unit.

This invention claims priority and is based on Provisional Application Ser. No. 60/492,867 filed Aug. 6, 2003.

### BACKGROUND OF THE INVENTION

This invention relates to articles of manufacture to display images, and more specifically, to structures that store photographs such that the user is able to manipulate the structure in order to display each photograph sequentially. The object of the invention is to create useful and enjoyable tangible ways to share images, and preferably, photographs. This specification describes methods of design and manufacturing. This specification also describes articles of manufacture.

In the prior art, there can be found rotating rings of four-sided polyhedra with images applied to the polyhedra faces. For example, in the 1987 reference book entitled “M. C. Escher Kaleidocycles” by Schattschneider, et al., pp. 20-22, it is taught that images applied to the image surfaces of rotating rings of polyhedra must be stretched or distorted in order to fit the image upon the faces of the ring. This feature is less than desirable since the image that is revealed is distorted in its visual presentation. Accordingly, it is desirable to provide a folding and rotating structure which overcomes the prior art limitations and otherwise enables distortion-free display of images thereon.

### BRIEF DESCRIPTION OF THE INVENTION

In one embodiment of the prior art, images that are placed on the four displayable image surfaces of a rotatable structure comprising six polyhedra (referred to within this specification as a 3-photo-ring) are such that the resulting images are distorted by about 15.5%; images in a rotatable structure comprising eight polyhedra (referred to within this specification as a 4-photo-ring) are distorted by about 22.5%. The distortion percentage increases as the number of polyhedra in a ring increases.

It is therefore desirable to build a distortionless rotatable display structure having zero distortion of each image. It turns out that a planar surface can slice through a conventional 3-photo-ring, passing through the center, through all six polyhedra of the rotating ring, with each intersection forming an equilateral triangle, so that a hexagonal-shaped section or display of an image can be embedded within the polyhedra ring. Another hexagonal section or display of a different image can be embedded on the reverse side of the first hexagonal section and within the polyhedra ring. When the 3-photo-ring is rotated, another hexagonal section or display of a third image can be embedded within the polyhedra ring of the first hexagonal section, and a hexagonal section of a fourth image can be embedded on its reverse side and within the polyhedra ring.

Each polyhedron of the polyhedra ring could be made out of clear resin, so that the embedded images are visible, or the embedded images could be made on very strong and thin materials, such as sheet metal or sheet acrylic and hinged together as planar sections rather than as solid polyhedra.

The inventive rotatable display structure can also be constructed with higher n photo-rings, such as a 4-photo-ring, without distorting the images, where n refers to the number of identically shaped and sized rhombuses (equilateral parallelograms) that each image display unit may be dissected into; and where 2n refers to the number of identically shaped and sized four-sided polyhedra in an n-photo-ring.

Each rotation of the inventive rotatable display structure displays a different internal triangular intersection for each four-sided polyhedron in the ring. For each rotation, an image can be placed on the displayed internal triangular intersections of the polyhedra. The distortionless rotatable display structure of the invention can display four images using all of the polyhedra if each four-sided polyhedron contributes one internal triangular intersection to each of the four images. A flat image section (e.g. a square, or a hexagon) can be placed within a planar region of the distortionless rotatable display structure.

Accordingly, it is an object of the invention to provide an improved folding and rotating display structure.

Still another object of the invention is to provide a folding and rotating structure which enables distortion free display of images thereon.

Still other objects and advantages of the invention will, in part, be obvious and will, in part, be apparent in the following description.

### BRIEF DESCRIPTION OF THE DRAWINGS

For a fuller understanding of the invention, reference is made to the following description, taken in connection with the accompanying drawings, in which:

FIG. 1 is a top plan view of a first polygonal display unit;

FIG. 2 is an exploded view of a plurality of image diamonds resulting from the dissection of the display unit of FIG. 1;

FIG. 3 is an exploded view of the image diamonds of FIG. 2 in an inverted or reversed condition;

FIG. 4 is a top plan view of the polygonal display unit reassembled from the image diamonds depicted in FIG. 3;

FIG. 5a is a top view of a first sequence of image diamonds disposed end-to-end;

FIG. 5b is a reverse top view of said first sequence of image diamonds disposed end-to-end;

FIG. 6a is a top view of a second sequence of image diamonds disposed end-to-end;

FIG. 6b is a reverse top view of said second sequence of image diamonds disposed end-to-end;

FIG. 7 is a perspective view of said first and second sequences of image diamonds interleaved together in order to form a multiply hinged chain assembly;

FIG. 8a is a top plan view of a folding and rotating toroidal display structure in accordance with the invention formed by interleaving the two ends of the chain assembly of FIG. 7 and revealing the first surface of the first display unit;

FIG. 8b is a side elevational view of the toroidal structure of FIG. 8a;

FIG. 9a is a top plan view of the inventive toroidal structure following rotation thereof in order to reveal a first surface of the second display unit;

FIG. 9b is a side elevational view of the toroidal structure depicted in FIG. 9a;

FIG. 10 is a top plan view of the inventive toroidal structure following further rotation thereof in order to reveal the reverse surface of the first display unit;

FIG. 11 is a top plan view of the inventive toroidal structure following still further rotation thereof in order to reveal a reverse surface of the second display unit;

FIG. 12a is a perspective view of the inventive toroidal structure encapsulated by a plurality of transparent polyhedral coverings in order to define a foldable display system;

FIG. 12b is a top plan view of the foldable display system depicted in FIG. 12a; and

FIG. 13 is a top plan view of a single image diamond suitable for use in the inventive toroidal structure.

### DETAILED DESCRIPTION

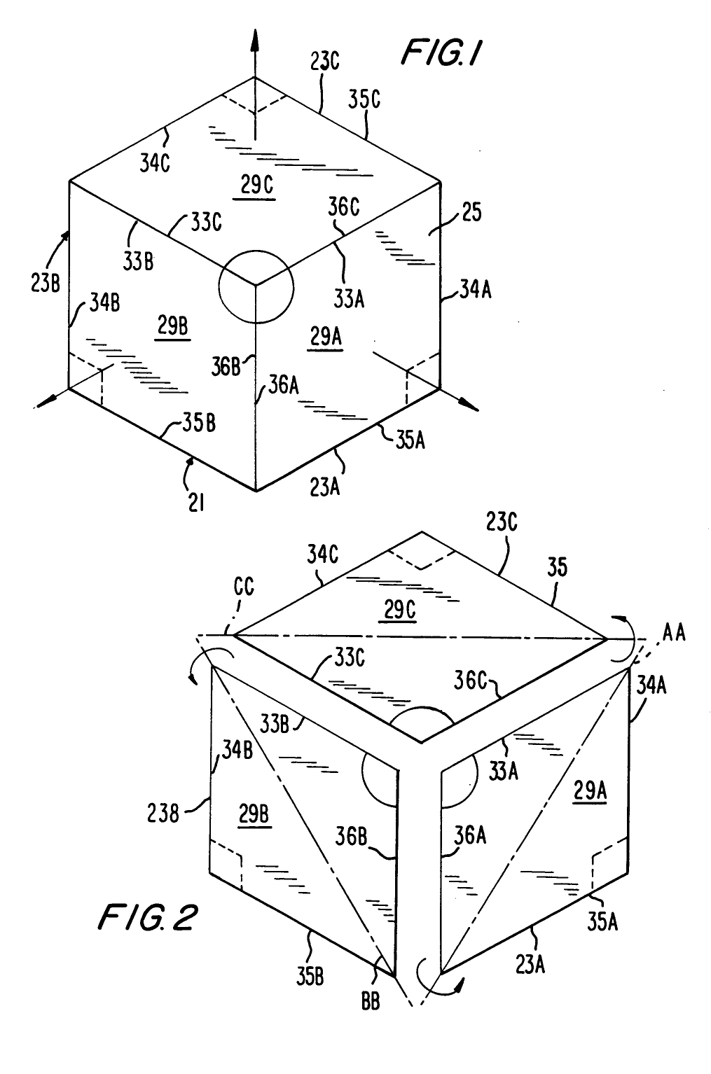

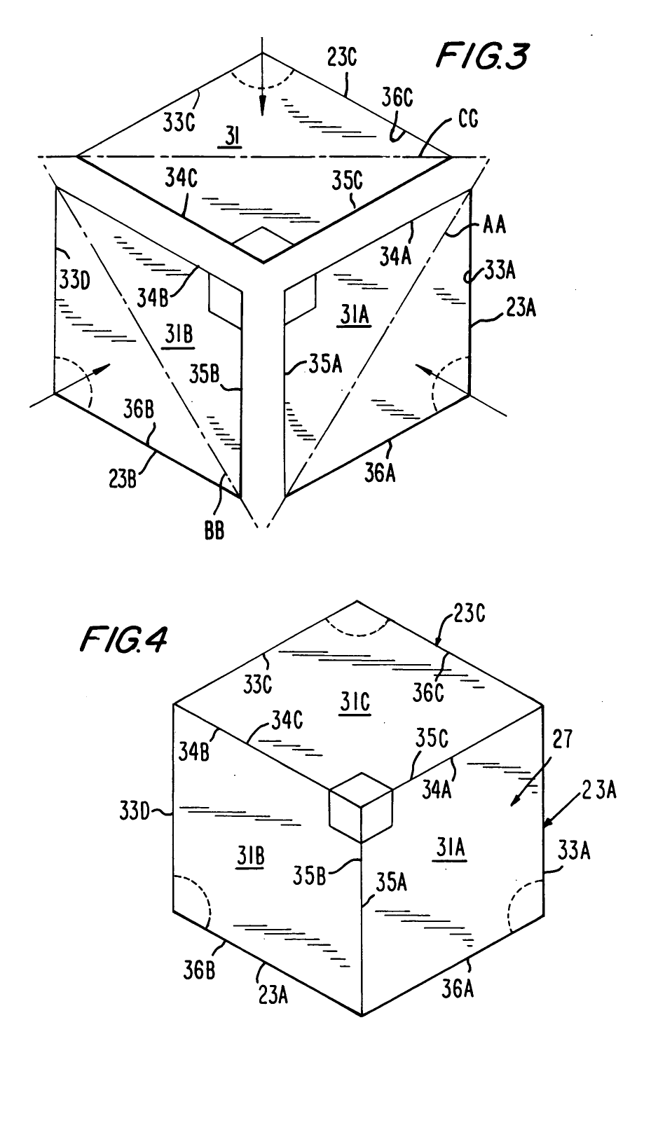

Referring first to FIG. 1, a first polygonal display unit suitable for use in the inventive toroidal structure is generally indicated at 21 and is defined by three image diamonds 23a 23b, and 23c. First display unit 21 has a front surface 25 and a reverse surface 27 (see FIG. 4); each image diamond 23a, 23b and 23c thus has, respectively, first image surfaces 29a, 29b and 29c and second or reverse image surfaces 31a, 31b and 31c (again see FIG. 4).

First display unit 21 comprises a polygonal shaped planar material, made out of sheet metal, plastic, acrylic, cardboard or paper, with each image diamond 23a, 23b and 23c defining equally sized parallelograms. Image diamond 23a is a rhombus (equilateral parallelogram) having four sides 33a, 34a, 35a and 36a. Similarly, image diamond 23b has four sides 33b, 34b, 35b and 36b, while image diamond 23c has four sides 33c, 34c, 35c and 36c. As shown in FIG. 1, side 36a of image diamond 23a is coextensive with side 36b of image diamond 23b, while side 33a of image diamond 23a is coextensive with side 36c of image diamond 23c, and side 33b of image diamond 23b is coextensive with side 33c of image diamond 23c.

In accordance with the invention, each image surface 29a, 29b and 29c of image diamonds 23a, 23b and 23c, respectively, together define a first visual presentation provided along front surface 25 of first display unit 21. By way of example, front surface 25 of display unit 21 may comprise a photograph as the visual presentation such that each of image surfaces 29a, 29b and 29c comprises a one-third portion thereof.

Referring now to FIG. 2, first polygonal display unit 21 is shown with image diamonds 23a, 23b and 23c in a dissected or separated condition such that each image diamond can be rotated about axes of rotation AA, BB, CC, respectively, in order to reveal or expose reverse image surfaces 31a, 31b and 31c thereof, as best shown in FIG. 3. In this condition, image diamonds 23a, 23b and 23c are then reassembled into polygonal display unit 21 (see FIG. 4). In this assembly, side 35a of image diamond 23a is coextensive with side 35b of image diamond 23b, side 34a of image diamond 23a is coextensive with side 35c of image diamond 23c, and side 34b of image diamond 23b is coextensive with side 34c of image diamond 23c. Thus, in the assembly of FIG. 4, reverse surface 27 of display unit 21 reveals a second visual presentation; in other words, reverse image surfaces 31a, 31b and 31c of respective image diamonds 23a, 23b and 23c together define said second visual presentation.

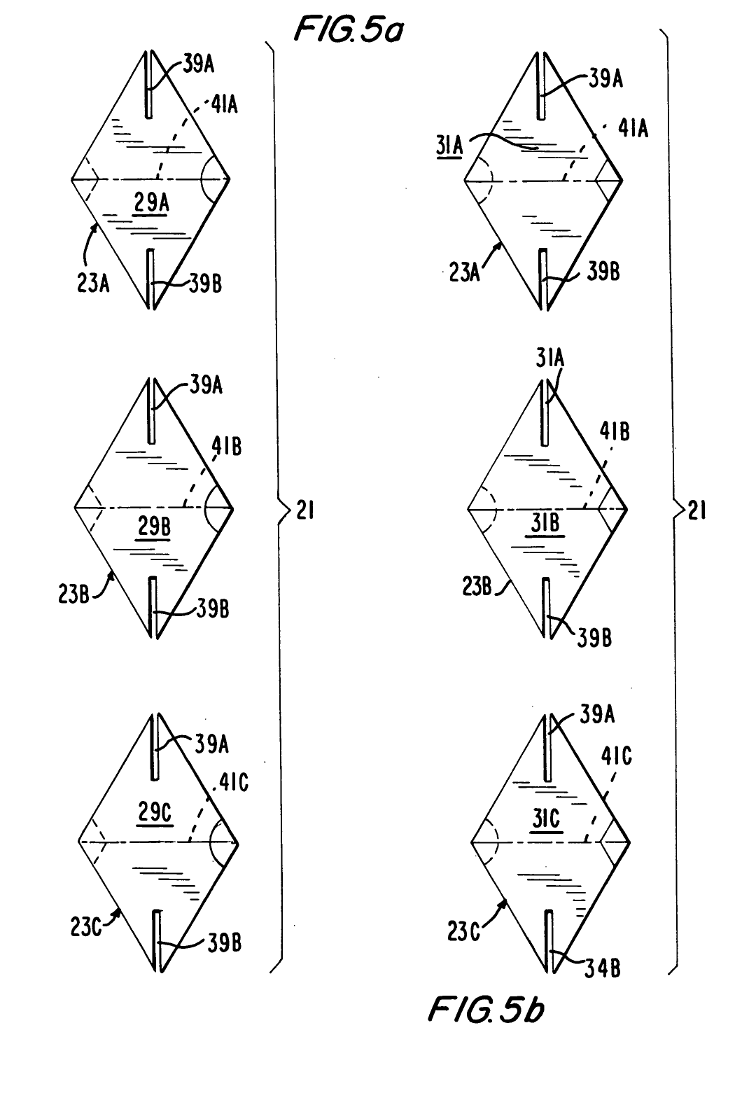

Turning now to FIGS. 5a and 5b, image diamonds 23a, 23b and 23c of first polygonal display unit are shown laid out in an end-to-end arrangement. Moreover, each image diamond is now formed with a pair of opposed slots 39a and 39b which, as shown hereinafter, are used for interleaving image diamonds 23a, 23b and 23c of first display unit 21 together with image diamonds of a second display unit in order to form a multiply hinged chain assembly. Significantly, each of image diamonds 23a, 23b and 23c are now also formed with hinge-like folds 41a, 41b and 41c between opposed corners thereof; these folds define a pair of isosceles triangles for each image diamond (for the case when n=3 the isosceles triangles are also equilateral). Folds 41a, 41b and 41c facilitate the folding of the image diamonds in order to form a multiply hinged chain assembly.

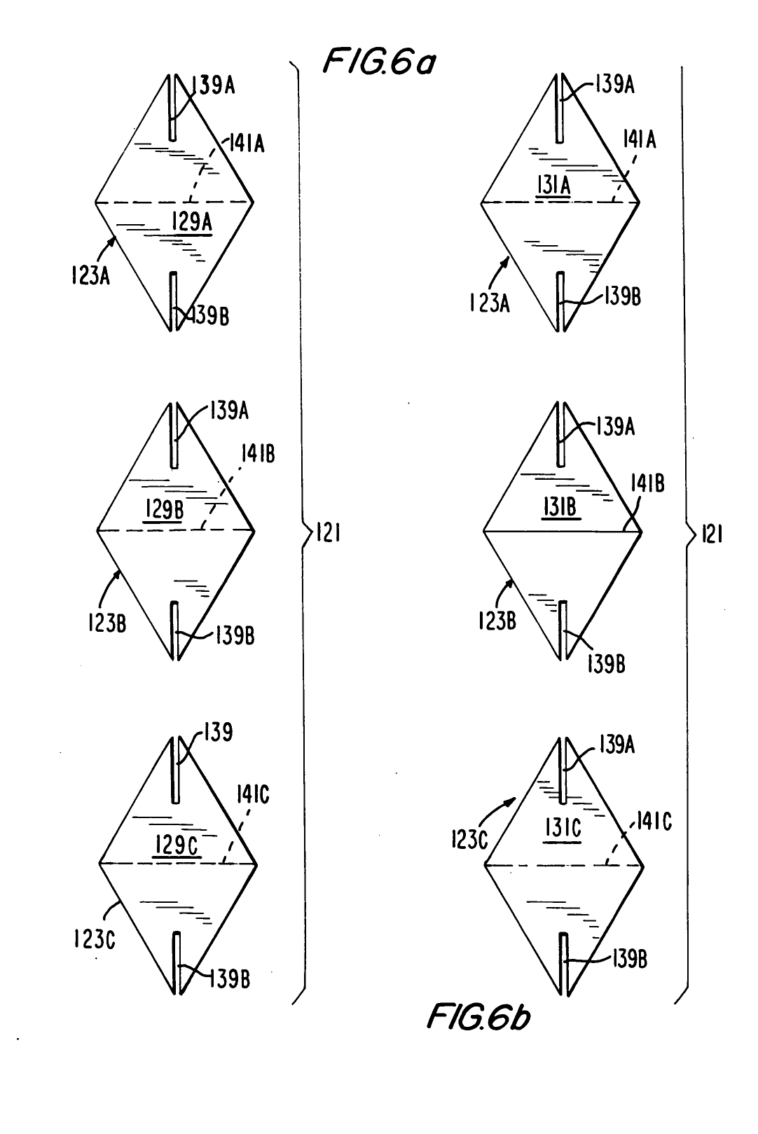

Referring now to FIGS. 6a and 6b, a second display unit 121 for use in the inventive toroidal structure is defined by three image diamonds 123a, 123b and 123c. Each image diamond 123a, 123b and 123c has first image surfaces 129a, 129b and 129c, respectively, and second or reverse image surfaces 131a, 131b and 131c, respectively. As before, each of image diamonds 123a, 123b and 123c define equally sized parallelograms and are bisected by hinge-like fold lines 129a, 129b and 129c in order to define a pair of isosceles triangles. (and in the embodiment where the number of image diamonds for each display unit is three, each isosceles triangle is also equilateral). Image surfaces 129a, 129b and 129c each define a one-third portion of a third visual presentation that is fully revealed when said image diamonds are assembled; similarly, image surfaces 131a, 131b and 131c each define a one-third portion of a fourth visual presentation that is fully revealed when said image diamonds are fully assembled. Like image diamonds 23a, 23b and 23c depicted in FIGS. 5a-5b, image diamonds 123a, 123b and 123c each include a pair of slots 139a and 139b at opposed corners thereof in order to form a multiply hinged chain assembly.

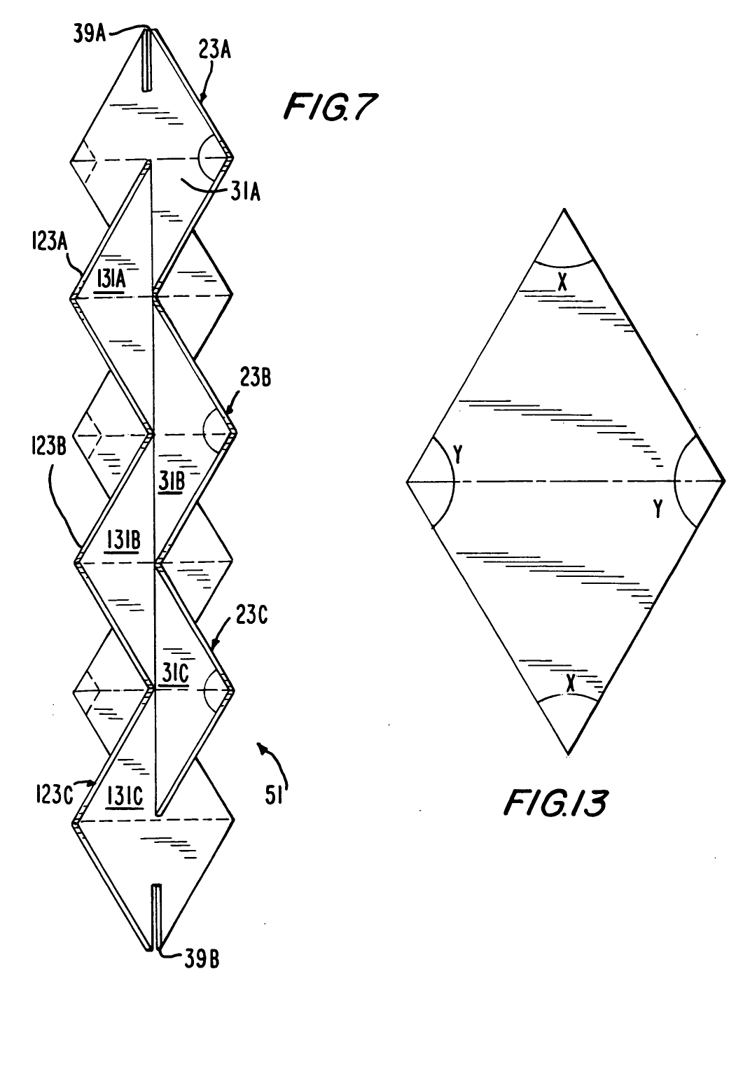

Turning now to FIG. 7, image diamonds 23a, 23b and 23c of first polygonal display unit 21 are shown interleaved together with image diamonds 123a, 123b and 123c of second polygonal display unit 21 in order to form a multiply hinged chain assembly 51. Interleaving is achieved by alternating engagement of slots 39a of image diamonds 23a, 23b and 23c with slots 139b of image diamonds 123a, 123b and 123c (although other mechanisms are possible), and alternating engagement of slots 39b of image diamonds 23a, 23b and 23c with slots 139a of image diamonds 123a, 123b and 123c. Thus, slot 39b of image diamond 23a mates with slot 139a of image diamond 123a; slot 139b of image diamond 123a mates with slot 3 la of image diamond 23b, etc.

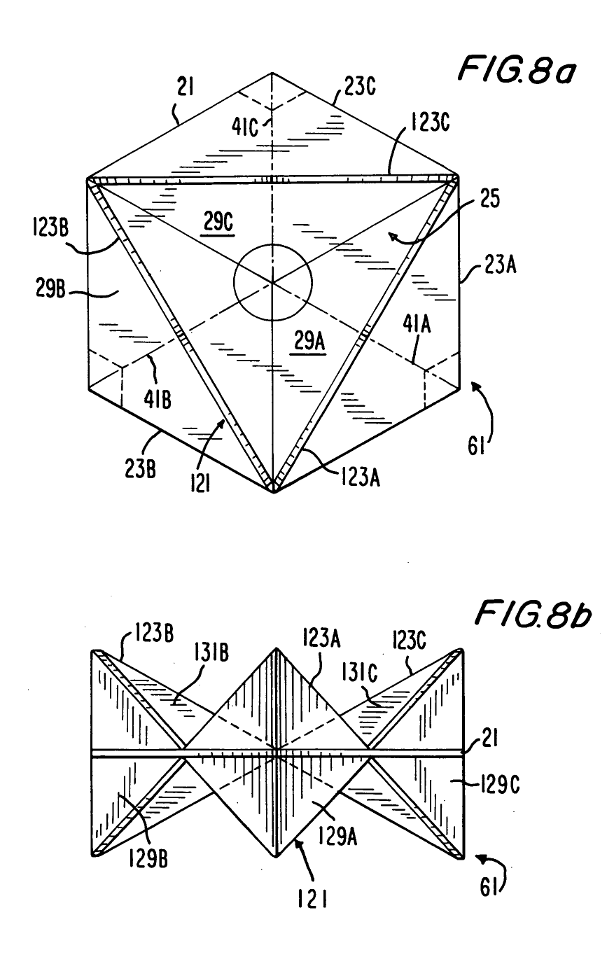

Turning now to FIGS. 8a and 8b, the preferred embodiment of the inventive folding and rotating toroidal structure, generally indicated at 61, is shown formed by matingly interleaving slot 39a of image diamond 23a with slot 39b of image diamond 123c. As shown in FIG. 8a, toroidal structure 61 is folded into a first rotational condition in order to display front surface 25 of display unit 21, comprising image surfaces 29a, 29b and 29c, and thereby revealing said first visual presentation.

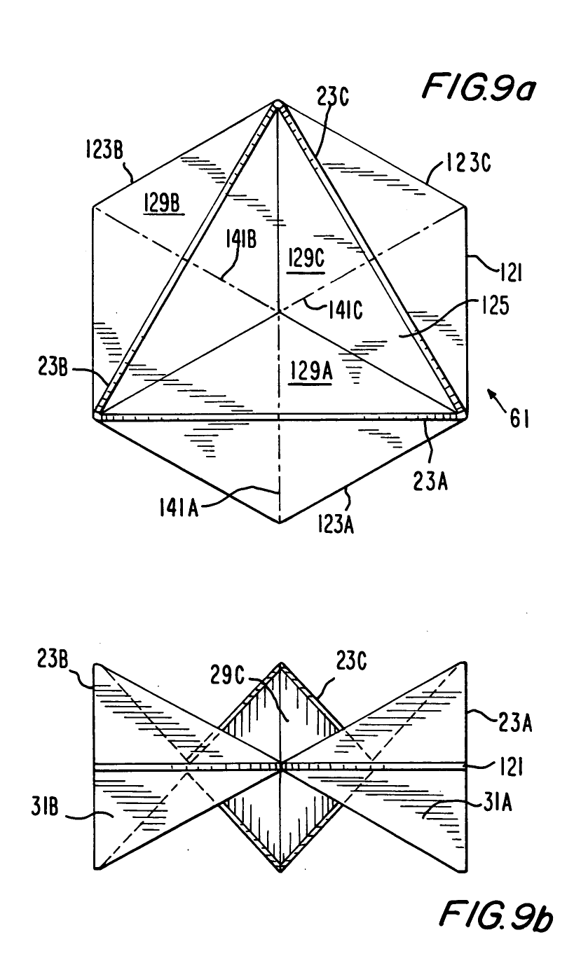

Referring now to FIGS. 9a and 9b, toroidal structure 61 is shown rotated into a second rotational condition in order to display front surface 125 of second display unit 121, comprising image surfaces 129a, 129b and 129c, and thereby revealing said third visual presentation.

Turning now to FIG. 10, toroidal structure 61 is now shown rotated into a third rotational condition in order to display reverse surface 27 of first display unit 21, comprising image surfaces 31a, 31b and 31c, and thereby revealing said second visual presentation.

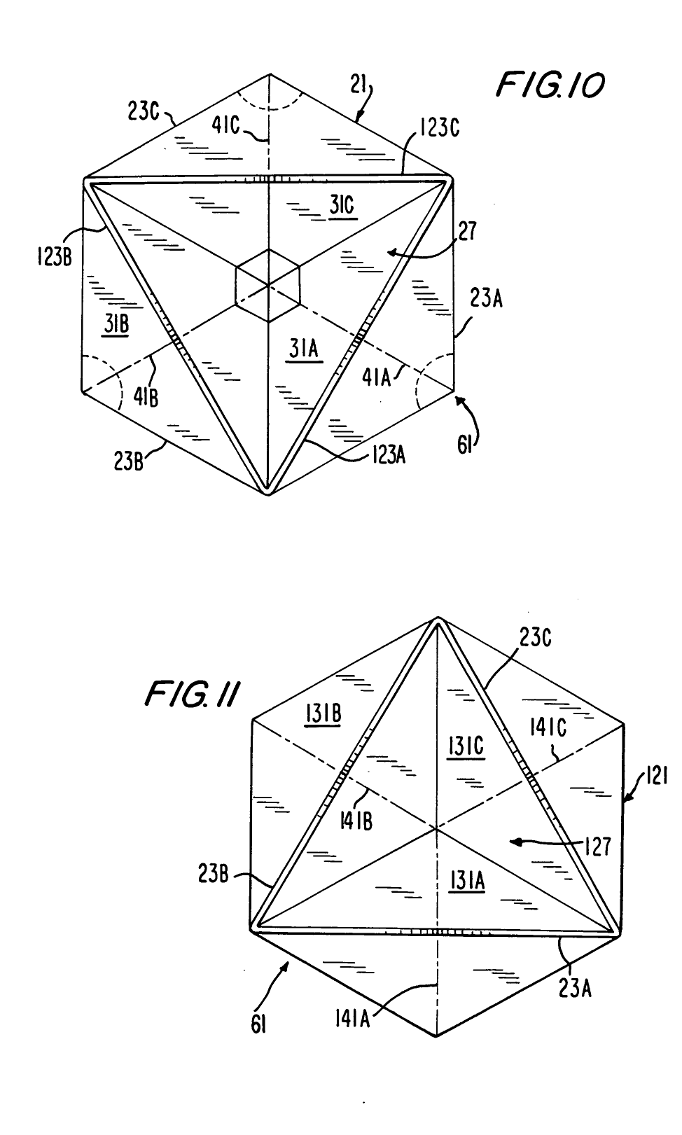

Referring now to FIG. 11, toroidal structure 61 is shown rotated into a fourth rotational condition in order to display reverse surface 127 of second display unit 121, comprising image surfaces 131a, 131b, and 131c, and thereby revealing said fourth visual presentation.

A further rotation of the toroidal structure returns it to the first rotational condition, thereby revealing the first visual presentation.

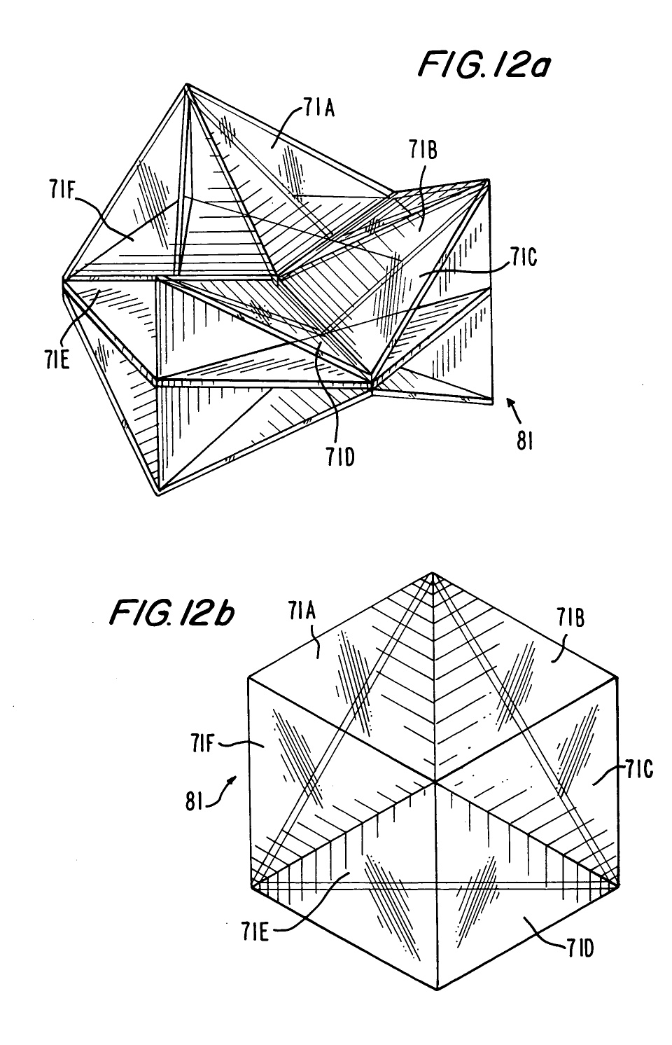

Turning now to FIGS. 12a and 12b, toroidal structure 61 is shown encapsulated by six transparent polyhedral covers 71a, 71b, 71c, 71d, 71e and 71f in order to define a foldable display system 81. In order to accommodate the thickness dimension of the polyhedral covers, each pair of triangles which define each image diamond of the display units must be disposed slightly spaced apart.

Although each display unit of the toroidal structure depicted in FIGS. 1-12b is defined by three image diamonds, with each image diamond bisected by a fold for hinging a pair of isosceles triangles, any number of image diamonds greater than three (3) may be used for each display unit so long as each of the two display units of the toroidal structure have the same number of image diamonds, and each of the image diamonds are identical, equilateral, and have the proper angular dimensions x and y as described below.

In accordance with the invention, each side of the image diamond has the same length—and the angles of the image diamonds are determined by n, the number of image diamonds in each display unit, such that each image diamond will have two angles of x, calculated by the equation 360°/n, and two angles of y, calculated by the equation 180°−360°/n.

Although the preferred embodiment of the inventive structure has each image diamond being a solid planar member, preferably from sheet metal or acrylic hinged together, each image diamond may instead be merely defined by a wire frame which can serve as the supporting structure for an image component.

The inventive method for constructing the toroidal structure of the invention is as follows:

Step 1. A prospective customer or consumer chooses four images for the toroidal structure, along with information such as the number of image diamonds and the size of the toroidal structure, the image rotation sequence type, and whether or not a clear polyhedral covering system should be included in its construction.

Step 2. The customer submits the information to a service provider such as an online digital photo service or an in-store photo service.

Step 3. A computer operator at the service provider receives the information submitted by the customer and selects or generates an image frame template which is a regular polygon determined by n (the number of image diamonds) as chosen by the customer (e.g. if n=4 the polygon is a square). The operator also generates the sequence of image frames, which correspond to the four displayed faces of the toroidal structure, placing the images provided by the customer in the sequence specified by the customer, and also placing each image in the orientation relative to the image frame as specified by the customer for the image rotation sequence type. The computer operator works to optimally avoid edges crossing people's faces or other significant elements though rotating, translating and scaling each image.

Step 4. The computer operator then generates a 3D digital model of the toroidal structure and also renders several different views of the model as digital images, along with a computer-generated movie of the model rotating in space and displaying the various faces. The operator then sends these proofs for approval by the customer before manufacturing.

Step 5. If the customer approves the proofs, then the process continues at Step 6. If the customer does not approve the proofs, then the customer can either choose to a) terminate the process or to b) request changes with the process subsequently continuing with Step 3.

Step 6. The operator then generates finished artwork for photographic reproduction, which have the images appropriately dissected and arranged such that when the unit is assembled, everything will be in the proper orientation and sequence. The computer operator will do this by using the information provided by the customer to perform Step 6A: creating image diamonds and Step 6B: laying out the image diamonds.

Step 7: The service provider then prints, cuts and scores the image diamonds.

Step 8: The service provider then folds and assembles the image diamonds into image diamond sequences.

Step 9: If the customer has chosen to have the toroidal structure constructed with a clear plastic polyhedral covering, the service provider then performs these optional steps: Step 9A: a computer operator selects or generates a cover surface frame template. Step 9B: the service provider then prints the template on clear Mylar® or another durable and transparent material, then cuts the cover out and scores it for folding. Step 9C: the service provider then folds and assembles the clear cover over the image diamond sequences, and glues them together with adhesive or other means.

Step 10: The service provider finally assembles the toroidal structure and glues it together with adhesive or other means.

Step 11. The finished toroidal structure is then shipped to the customer.

In accordance with the invention, each polygonal display unit of the inventive toroidal structure comprises a plurality of image diamonds and may be designed to “lock” into each of its four rotational display positions, so that it takes a little extra force to place the display unit into a locked position, and to pull it out of a locked position. This might be done with permanent magnets so that a magnetic circuit is closed in each locked position, and then broken to unlock it.

In the inventive toroidal structure, each surface of a display unit could have multiple images, preferably with the same orientation.

Although the inventive method outlined hereinabove describes a computer operator running a program at another location, it would be possible to design software that the customer could use while at home—either as an enhancement such as a plug-in to Adobe Photoshop, a standalone program, or possibly as a web service.

Although the inventive method describes a service provider for manufacturing the inventive toroidal structures, it would be possible for the customer (or end user) to also print out the photos and appropriately apply the photos to image diamonds in order to construct the structure, even at home.

In carrying out the invention, it is also possible for a manufacturer to construct physical toroidal structures which allows the insertion of photos into them, in a similar manner as with the insertion of photos into photo frames.

When encapsulating a distortionless toroidal structure with a transparent polyhedral surface covering, there are interstices in each of the polyhedra of the structure between the display units' surfaces and the surface of the covering. These interstices could be filled with a liquid such as water, and artificial snowflakes could be placed inside these interstices, so that the device could be used for snow scene displays. These interstices could also be filled with other materials, so that miniature dioramas are created.

The inventive toroidal structure could be used in different sizes as an accessory for furniture, such as a coffee table, or shadow boxes. Moreover, by enlarging the hole in the center of each display unit, a jewelry ring might be created.

The inventive toroidal structure could store a temporal sequence of photographs, such as those produced in a photobooth.

The inventive toroidal structure could store a spatially magnified sequence of photographs, such as in Ray and Charles Eames famous work “Powers of Ten,” e.g., each photograph in the sequence could be part of the same image, each magnified a power of ten over its predecessor.

The inventive toroidal structure could store a spatially rotated or translated sequence of photographs, such as different sections of a panorama.

The inventive toroidal structure could also store a sequence of photographs, whereby each photograph was identical except for some change of element, such as color, or replacing the colors of a traffic light with the sequence red, green, blue—or changing the clothing on a fashion model four times.

The inventive toroidal structure could be mechanically passive, so that the end-user would need to manually rotate the n-photo-ring, or it could be mechanically active, so that the photo-ring would automatically rotate using motors or actuators.

The images viewable on the display units of the toroidal structure of the invention could be static, or they could be computer displays. For example, it could be like tangible media devices from MIT, whereby an internal computer would have a database of images, each rotation would queue the internal computer to bring forth a new image, and discard a previous image, and the new image would automatically be tessellated into triangles which would be stretched appropriately and displayed electronically.

Consistent with the invention, there could be audio, for example music, or recorded voices associated with the inventive toroidal structure, that might be triggered by the end user's interactions therewith.

The inventive toroidal structure could be made to stand up on end at any one of the four display positions, tilted like a portrait on a desk or mantelpiece, and thereby displaying the selected photo image.

The polyhedral covering of the toroidal structure could be made out of an optically transparent material such as crystal, and then 3D images could be laser etched thereon.

A distortionless toroidal structure could be designed whereby the display unit surfaces are mirrored surfaces. Then, 3D objects could be embedded or laser-etched into optically transparent material such as crystal which would be placed in the interstices between the display unit surfaces and the polyhedral surface covering. A clear surface polyhedral covering would not be required if the interstices were solid. Alternatively, a clear covering could be used, and real 3D objects placed inside the interstices. This would make the embedded 3D objects appear floating in mid-air. For example, textual words like “GREEN” could be embedded such that it lies upon the mirrored surface of a display unit, thus appearing as a floating word. Moreover, using 3D laser etching processes, a field of stars or a constellation could be embedded, and a mirror could be used on the display unit surfaces. It is also possible that the toroidal structure could use a transparent polyhedral covering. Consequently, one can then embed 3D images into the toroidal structure using no mirrors or images along the display unit surfaces. As a result, no image plane occludes the view through the structure, and one can see entirely through to the other side of the structure, viewing whatever 3D images are embedded there within.

In accordance with the inventive structure, the display unit surfaces could incorporate holographic images.

In the inventive structure, the display unit surfaces could use 3D images, using a variety of 3D image display techniques including stereo images, lenticular displays, etc.

The display unit surfaces of the inventive structure could be electroluminescent or florescent, thereby backlighting the embedded 3D objects or images.

It will thus be seen that the objects set forth above, and those made apparent from the preceding description, are efficiently attained, and since certain changes may be made in the products set forth above without departing from the spirit and scope of the invention, it is intended that all matter contained in the above description and shown in the accompanying drawings shall be interpreted as illustrative and not in a limiting sense.

It is also to be understood that the following claims are intended to cover all the generic and specific features of the invention herein described, and all statements of the scope of the invention, which, as a matter of language, might be said to fall therebetween.

1. A folding and rotating toroidal structure comprising:
first and second polygonal display units, each polygonal display unit having a first image surface and a second image surface, each polygonal display unit divided into and comprised of the same number of image diamonds with that number being at least three;
wherein all of said image diamonds for both polygonal display units are rhombus-shaped and congruent to one another with each image diamond of either polygonal display unit having four sides and first and second pairs of opposed corners;
wherein any of said image diamonds of each polygonal display unit has (a) one of its sides selectively co-extensive with one side from another of said image diamonds of said polygonal display unit and (b) a second of said sides selectively co-extensive with one side from a second of said image diamonds of said polygonal display unit;
wherein each image diamond of each said polygonal display unit is bisected into two congruent isosceles triangles by a fold line which runs between said first pair of opposed corners;
wherein said image diamonds of said polygonal display units are alternatingly interleaved at said second pair of opposed corners such that each image diamond from either polygonal display unit is attached in a substantially perpendicular orientation to two image diamonds of the other polygonal display unit, one at each of said second pair of opposed corners; and
wherein each said image diamond of each said polygonal display unit has a first side image surface and a second side image surface, said first side image surfaces of the image diamonds of one polygonal display unit together defining a first visual presentation when said display unit is rotated to a first position, said second side image surfaces of the image diamonds of said one polygonal display unit together defining a second visual presentation when said display unit is rotated to a second position.

2. The structure of claim 1, wherein said structure is encapsulated by a covering defined by a plurality of four-sided polyhedra of twice the number as the number of image diamonds in each polygonal display unit.

3. The structure of claim 1, wherein said two isosceles triangles of each said image diamond are spaced apart.

4. The structure of claim 1, wherein each corner of said first pair of opposed corners has an angle calculated by the equation 360°/n, wherein n is the number of image diamonds in each display unit.

5. The structure of claim 4, wherein each corner of said second pair of opposed corners has an angle calculated by the equation 180°−360°/n.

6. The structure of claim 1, wherein each image diamond of each said display unit has first and second opposed slots respectively located at said opposed corners of said second pair, said first slot of each said image diamond of said first polygonal display unit selectively mating with said second slot of one of said image diamonds of said second polygonal display unit, said second slot of each said image diamond of said first polygonal display unit selectively mating with said first slot of another of said image diamonds of said second polygonal display unit.
